(19) United States
(12) Patent Application Publication
(10) Pub. No.: US 2011/0282748 A1
(43) Pub. Date: Nov. 17, 2011

(54) APPARATUSES, METHODS AND SYSTEMS FOR USING A PERSONALIZED DATA REPOSITORY

(76) Inventor: Peter Ciurea, Orinda, CA (US)

(21) Appl. No.: 13/085,021

(22) Filed: Apr. 12, 2011

Related U.S. Application Data
(60) Provisional application No. 61/323,235, filed on Apr. 12, 2010.

(51) Int. Cl. G06Q 30/00

(52) U.S. Cl. 705/14.64

(57) ABSTRACT

The APPARATUS, METHODS AND SYSTEMS FOR USING A PERSONALIZED DATA REPOSITORY (“PDR”) transform merchant promotional offer inputs and individual user or consumer transaction inputs into targeted promotional offer outputs, which are distributed to individual user or consumers. In one embodiment the method includes a personalized data repository processor-implemented method that includes receiving, over a communications network, communication messages associated with a user's mobile communication device, whereby the communication messages associated with the user's mobile communication device are aggregated and packaged, upon authorization, from the mobile communication device. Merchant promotional offer information corresponding to promotional goods information or promotional services information is received over the communications network. The received user's sale transaction information is then correlated with the received promotional offer information for determining one or more targeted promotional offers based on the promotional goods or promotional services information and the purchased goods or purchased services information. The one or more targeted promotional offers are sent over the communications network to a mobile communication device of the user.

### RELATED APPLICATIONS

Applicant hereby claims priority under 35 USC §119 from U.S. provisional patent application Ser. No. 61/323,235, filed Apr. 12, 2010, entitled “Personalized Data Repository,” attorney docket no. P-41346PRV 120270-113PV. The entire contents of the aforementioned application is herein expressly incorporated by reference.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present invention is directed generally to apparatuses, methods, and systems for analyzing data, and more particularly, to APPARATUSES, METHODS AND SYSTEMS FOR USING A PERSONALIZED DATA REPOSITORY.

### BACKGROUND

Consumers engage in different transactions that are associated with, for example, different products or services. These different transactions produce data that may be stored for analysis and/or processing.

### BRIEF DESCRIPTION OF THE DRAWINGS

The accompanying appendices and/or drawings illustrate various non-limiting, example, inventive aspects in accordance with the present disclosure:

FIG. 1A is of a block diagram illustrating example aspects of providing targeted promotional offers in some embodiments of the PDR;

FIG. 1B is of a block diagram illustrating example aspects of a targeted promotional offer process in some embodiments of the PDR;

FIG. 2 is of a logic flow diagram illustrating a targeted promotional offer process in some embodiments of the PDR;

FIG. 3 is of a block diagram illustrating other example aspects of a targeted promotional offer process in some embodiments of the PDR;

FIG. 4 is of a logic flow diagram illustrating other targeted promotional offer processes in some embodiments of the PDR;

FIG. 5 is of a block diagram illustrating example aspects of a retrievable account information process in some embodiments of the PDR;

FIG. 6 is of a logic flow diagram illustrating a retrievable account information process in some embodiments of the PDR;

FIG. 7 is of a block diagram illustrating example system architecture aspects of some embodiments of the PDR;

FIG. 8 illustrates an example of a web-interface presented to a user or consumer according to some embodiments of the PDR;

FIG. 9 is an example of a mobile communication device and centralized data transfer (CDF) application according to some embodiments of the PDR; and

FIG. 10 is of a block diagram illustrating embodiments of the PDR controller.

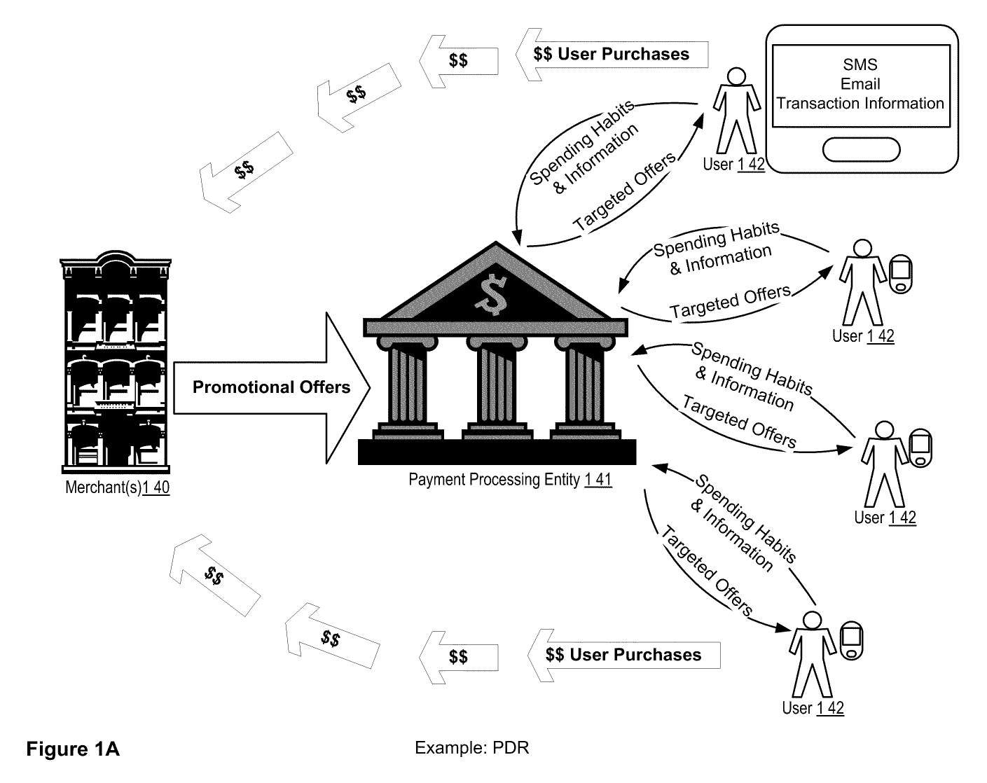

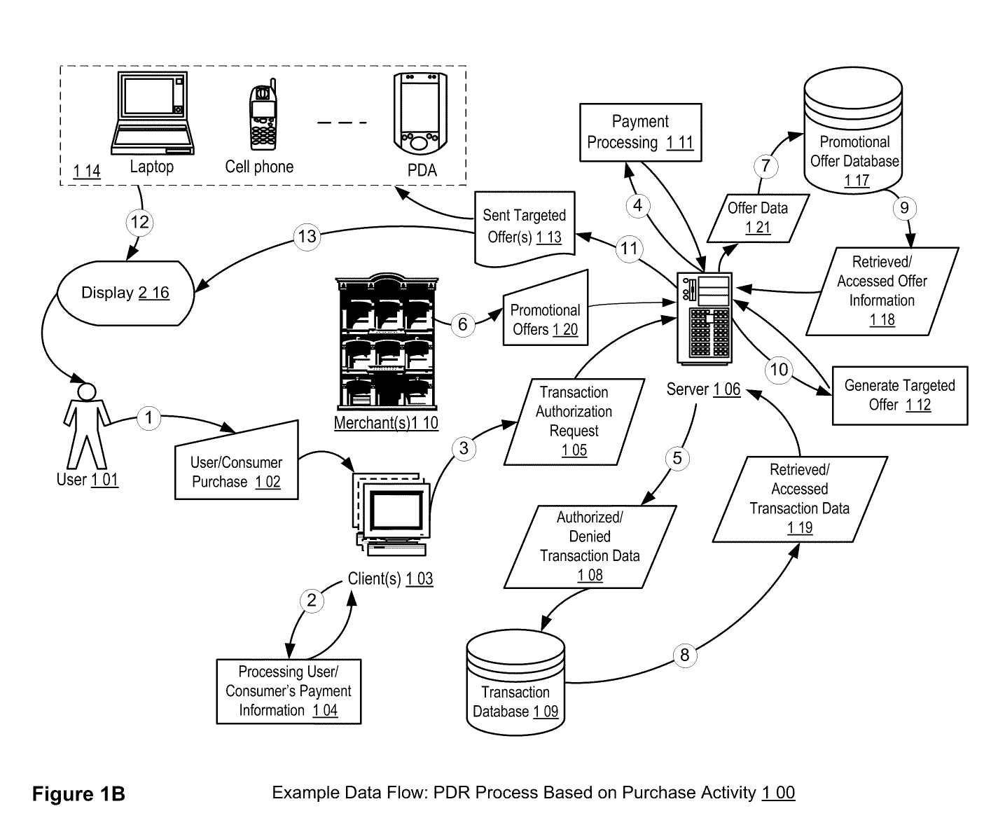

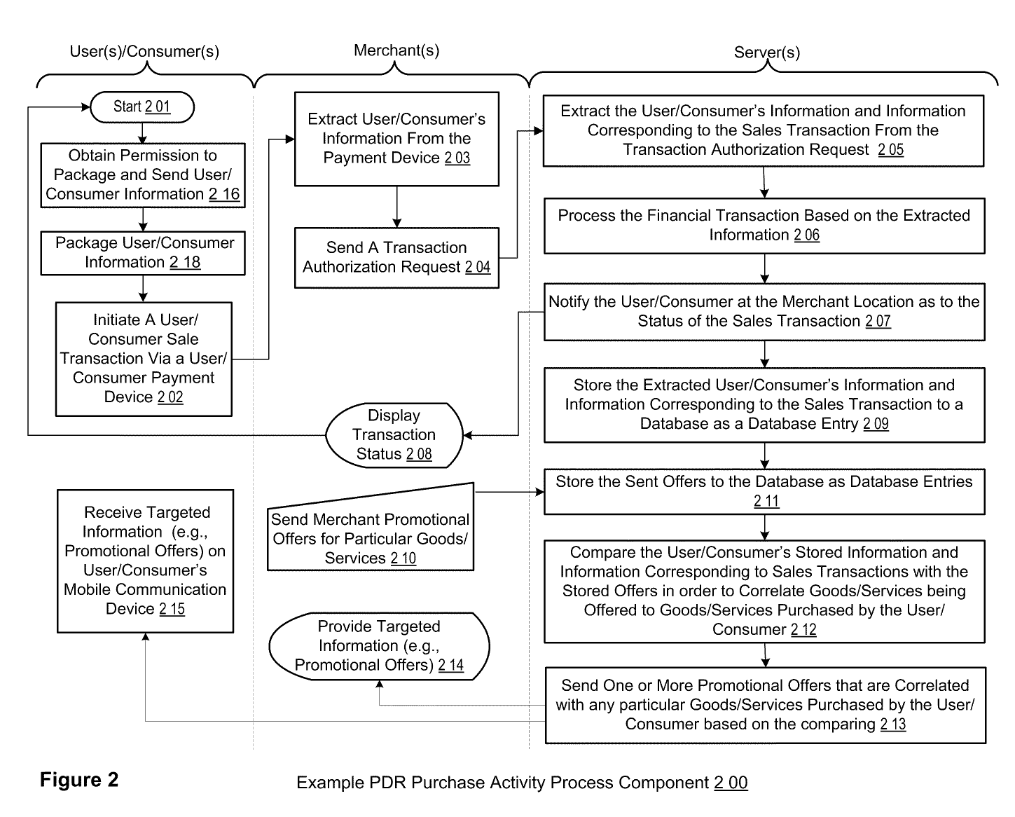

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### PDR

Cloud-based computing (hereinafter the “cloud”) facilitates, among other things, access to web-based software applications and website services without the requisite need for the local installation, maintenance, and updating of such software or services on the user's computational device (e.g., PC, laptop, smartphone, etc.). For example, a particular server located somewhere on a communication network may host several software applications that may be accessed by one or more users via a web browser (e.g., Internet Explorer™, Firefox™, etc.). Thus, the cloud may facilitate the provision of several data services to consumers utilizing mobile devices such as, for example, smartphones, cell phones, personal digital assistants (PDAs), laptops, tablet PCs (e.g., Apple iPad™), etc.

FIG. 1A is of a block diagram illustrating example aspects of providing targeted promotional offers in some embodiments of the PDR. A payment processing entity 141 receives spending habits and information associated with users or consumers 142. Since the payment processing entity 141 processes user or consumer financial transactions, it is capable of accumulating a vast amount of data associated with user or consumer 142 spending habits. In addition, the payment processing entity 141 may also receive promotional offers from various merchants 140. Using a mobile communication device, each user or consumer 142 is capable of performing sales transactions that are processed by the payment processing entity 141. Further, each user or consumer may also transmit or authorize the transmission of other information to the payment processing entity 141 via their respective mobile communication devices. This transmitted information may include, for example, SMS, Email, and other user-authorized messaging data. Based on the received promotional offers, user or consumer financial transactions, and other user or consumer information, the payment processing entity 141 may provide each individual user or consumer 142 with targeted offers (e.g., 10% discount off laptop purchases) that relate to the user or consumer's spending habits. In turn, the user or consumer's receipt of target offers encourages the user or consumer to purchase more items or services from the various merchants 140.

FIG. 1B is of a block diagram 100 illustrating example aspects of a targeted promotional offer process in some embodiments of the PDR. A user or consumer 101 may desire to make a sales purchase by providing payment information (e.g., bank account or credit card data) 102, via a payment device, to a client device 103 such as a merchant's point-of-sale (POS) terminal. In some example aspect, the client device 103 may be a user or consumer's 101 web-enable computer (e.g., laptop, desktop, tablet, etc.) or a mobile communication device (e.g., PDA, smartphone, etc.). The client device 103 processes the user or consumer's payment information 104 and transmits this payment information in the form of a transaction authorization request 105 to a computer server 106. The server 106 may then facilitate a payment transaction process 111 with several other financial entities (not shown) such as, for example, an issuer (e.g., user's bank), an acquirer (e.g., merchant's bank), and a payment processor institution (e.g., VISA). Upon processing of the user or consumer's transaction request, the server receives a “transaction authorized” or a “transaction denied” message from one of the financial entities (e.g., VISA).

The server sends transaction data 108 (e.g., user or consumer's financial account information) associated with the “authorized” or “denied” transaction to a transaction database 109. The transaction data may include information corresponding to the sales purchase (e.g., goods or services purchased) such as a description code (e.g., NAICS: North American Industry Classification System) associated with the purchased item, cost of the purchased item, and date of transaction. The transaction data may also include information regarding one or more of the user or consumer's mobile communication devices 114 such as, but not limited to, the device name (e.g., Apple iPhone™, Motorola Droid™, etc.), means of communication adopted by each device (e.g., SMS message, Email, etc.), and a user-determinable device preference (e.g., Apple iPhone™ device) for establishing communications. In some implementations, the server 106 may send the transaction data 108 to the transaction database 109 based on one or more predefined conditions. For example, in some aspects, only “Authorized” transaction data and not “Denied” transaction data is stored in database 109. According to other aspects, for example, transaction data associated with certain purchase prices (e.g., purchase>$100, purchase<$50, purchase of $1-$75) may be stored in the database 109. In other implementations, both “Authorized” transaction data and “Denied” transaction data is stored, whereby each may have different assigned predefined conditioned. For example, “Authorized” transaction data may include transactions of greater than $100, whereas “Denied” transaction data may include transactions that are greater than $200.

The server computer 106 may also receive 120 and store 121 promotional offer information that correspond to various goods or services from different merchants 110 in a promotional offer database 117. For example, one merchant promotional offer may include “Merchant X: 20% reduction from the purchase of any laptop computer within the month of April.” According to another example, “Merchant Y: 6-months of free software and hardware support provided for any laptop computer purchased within the month of May.” For example, transmission of merchant promotional offer information between the merchants 110 and the computer server 106 may be in the form of a HTTP POST or GET message. Alternatively, the various merchants 110 may send the merchant promotional offer information to the computer server 106 in the form of an email, SMS message, or via any other communication protocol established between, and supported by, both the merchant 110 and the server 106.

The server 106 retrieves or accesses both stored transaction data 119 from the transaction database 109 and stored merchant promotional offer information 118 from the promotional offer database 117. The server then processes the retrieved or accessed transaction data in along with the retrieved or accessed merchant promotional offer information 118 in order to generate a targeted promotional offer 112 for each particular user or consumer utilizing the PDR system. For example, when a particular user or consumer's transaction data includes sales information corresponding to the purchase of camera equipment, any merchant promotional offer information corresponding to camera equipment will be identified as a targeted promotion for that particular user or consumer.

The targeted promotional offer is then sent 113 to any predetermined one of the user or consumer's 101 mobile communication devices 114 for display 116. The displayed promotion may be presented in many different forms. For example, the sent offer 113 may include an attached or downloadable PDF document. According to another example, the sent offer 113 may include one or more barcodes that may be displayed on one of the mobile communication device 114. Thus, at a merchant's business location, the barcode or barcodes displayed by the mobile communication device may be scanned in order to receive a particular discount on the sale of particular goods or services. Alternatively, for example, the displayed targeted promotion may be a promotional code that includes a description of the particular promotion (e.g., Code: 4eRFT34X; 40% off all laptop computers). At a merchant's point-of-sale (POS), the promotional code (e.g., 4eRFT34X) may be submitted when the user is purchasing, for example, a laptop computer.

The above-described PDR process may generate a request for generating promotional data, e.g., 120, whereby, for example, the server, e.g., 106, may receive a HTTP(S) POST request similar to the example below:

```
POST /requestpromtions.php HTTP/1.1
Host: www.PDRprocess.com
Content-Type: Application/XML
Content-Length: 788
<?XML version = “1.0” encoding = “UTF-8”?>
<promotionalData_request>
    <timestamp>2011-02-22 17:00:01</timestamp>
    <purchase_range>$20-$250</purchase_range>
    <merchant_params>
        <merchant_id>3FBCR4INC</merchant_id>
        <merchant_name>Best Buy</merchant_name>
        <merchant_Industry>electronic goods</merchant_industry>
        <merchant_Location>Manhattan 10022</merchant_Location>
        <merchant_promotions>
            <promotion_ID>123YTR</promotion_ID>
            <promotional_item>laptop computers</promotional_item>
            <promotional_sale>%25 Discount</promotional_sale>
            <promotional_redemption_limit>100</
            promotional_redemption_limit>
            <promotional_requirements>3
            referrals</promotional_requirements>
        </merchant_promotions>
    </merchant_params>
</promotionalData_request>
```

The above-described PDR process may also generate a request for user or consumer transaction data, e.g., 105, whereby, for example, the server, e.g., 106, may receive a HTTP(S) POST request similar to the example below:

```
POST /requestpromtions.php HTTP/1.1
Host: www.PDRprocess.com
Content-Type: Application/XML
Content-Length: 788
<?XML version = “1.0” encoding = “UTF-8”?>
<transactionData_request>
<timestamp>2011-02-22 17:00:01</timestamp>
    <user_account_params>
        <user_account_ID>1234567JS</ user_account_ID>
        <account_name>John Smith</account_name>
        <account_type>credit</account_type>
        <account_num>123455789012345</account_num>
    </user_account_params>
    <merchant_params>
        <merchant_id>3FBCR4INC</merchant_id>
        <merchant_name>Apple Store</merchant_name>
        <merchant_Industry>electronic goods</merchant_industry>
        <merchant_Location>Manhattan 10022</merchant_Location>
        <purchase_price>$599</purchase_price>
    </merchant_params>
    <purchase_summary>
        <num_products>1</num_products>
        <purchased_item>iPad tablet computer</purchased_item>
    </purchase_summary>
</transactionData_request>
```

The above-described PDR process may also generate a user or consumer requested targeted Offer, e.g., 113, whereby, for example, the server, e.g., 106, may generate a HTTP(S) POST message similar to the example below:

```
POST /targetedpromtions.php HTTP/1.1
Host: www.PDRprocess.com
Content-Type: Application/XML
Content-Length: 788
<?XML version = “1.0” encoding = “UTF-8”?>
<targetedPromotion_message>
  <timestamp>2011-02-22 17:00:01</timestamp>
  <user_information>
    <user_ID>1234JS23</user_ID>
    <user_name>John Smith</user_name>
    <user_account_type>credit</user_account_type>
    <user_address> 420 E 1000th Street, NY, 10022</user_address>
  </user_information>
  <merchant_params>
    <merchant_id>3FBCR4INC</merchant_id>
    <merchant_name>Best Buy</merchant_name>
    <merchant_Industry>electronic goods</merchant_industry>
    <merchant_Location>Manhattan 10022</merchant_Location>
  </merchant_params>
  <target_promotion>
    <promotion_ID>123YTR</promotion_ID>
    <promotional_item>laptop computers</promotional_item>
    <promotional_information>%25 Discount off all laptop
    computer</promotional_information>
    <promotion_expiry>June 15, 2011</promotion_expiry>
  </target_promotion>
  <redemptions>
    <redemption_code>jky123</redemption_code>
    <redemption_requirement>3 referrals</redemption_requirement>
    <redemption_source>www.redemptionpromo123ABC.com/
    redemption.php
    </redemption_source>
    <redemption_hash>digital certificate 1</redemption_hash>
    <redemption_target>
      <product_ID>abc123</product_ID>
      <product_URL>www.amazon.com/product.abc123
      </product_URL>
      <redemption_source>www.amazon.com/product.abc123
      </redemption_source>
      <redemption_item>basket coupon123(10%)</redemption_item>
  </redemptions>
  <user_device>
    <user_DeviceID>SN1023456</user_DeviceID>
    <selected_Device_model>iPhone</selected_Device_model>
  </user_device>
</targetedPromotion_message>
```

Offers may be sent via Email, SMS, MMS, or any other suitable messaging and/or communication means.

The above-described PDR process may also generate a user or consumer requested purchase, e.g., 102, whereby, for example, a client or server computer, e.g., 103, 106, may receive a HTTP(S) POST message similar to the example below:

```
POST /user_purchase.php HTTP/1.1
Host: www.PDRprocess.com
Content-Type: Application/XML
Content-Length: 788
<?XML version = “1.0” encoding = “UTF-8”?>
<transactionData_request>
<timestamp>2011-02-22 17:00:01</timestamp>
    <user_account_params>
        <account_issuer_ID>1234rtyg</ user_account_ID>
        <account_issuer_name>Chaz Bank</account_issuer_name>
        <payment_processor_ID>1234visa</payment_processor_ID>
        <account_name>John Smith</account_name>
        <account_type>credit</account_type>
        <account_num>123455789012345</account_num>
    </user_account_params>
    <merchant_params>
        <merchant_id>3FBCR4INC</merchant_id>
        <merchant_name>Apple Store</merchant_name>
        <merchant_Industry>electronic goods</merchant_industry>
        <merchant_Location>Manhattan 10022</merchant_Location>
        <purchase_price>$599</purchase_price>
    </merchant_params>
    <purchase_summary>
        <num_products>1</num_products>
        <purchased_item>iPad tablet computer</purchased_item>
    </purchase_summary>
</ user_purchase>
```

FIG. 2 is of a logic flow diagram 200 illustrating a targeted promotional offer process in some embodiments of the PDR. A user or consumer may initiate a sale transaction via the user or consumer's payment device 202. The payment device may be any mechanism by which the user or consumer is able to pursue a sales transaction with a merchant. For example, a payment device may include a smart card (e.g., Visa payWave™ technology), a credit card having a magnetic strip, an electronic wallet, or any mobile communication device (e.g., smart phone, PDA, etc.) capable of facilitating a sales transaction at a merchant's POS terminal. Prior to initiating the transaction 202, the user or consumer may be required to confirm that permission is given to package and send the user or consumer's information to a merchant or other entity 216 (e.g., VISA). For example, in the event that the user or consumer uses a mobile communication device as an e-wallet, an application executing an e-wallet function may request the user or consumer's permission prior to packaging and sending the user or consumer's information to a merchant. Once the user or consumer grants permission, the user or consumer's information may be packaged for transmission to a merchant or other entity 218 upon initiation of the sales transaction 202.

At a merchant's business location, once the user or consumer's information is extracted from the payment device 203 by the POS device, a transaction authorization request is sent 204 from the merchant's POS device to at least one computer server associated with a payment transaction processor (e.g., VISA). At the server, the user or consumer's information (e.g., user's identification, user's account information, user's mobile communication device information, etc.) and information corresponding to the sales transaction (e.g., price, description of goods/services, etc.) is extracted from the transaction authorization request 205.

In conjunction with computer servers of several other financial entities (e.g., user's issuer bank, merchant's acquirer bank, etc.), the information extracted from the transaction authorization request (e.g., user's account information and purchase information) is processed 206. Based on this processing, the user or consumer is notified as to the status of the initiated sales transaction 207, whereby a status notification (i.e., “Authorized” or “Denied”) message is sent to, and displayed at, the merchant's POS terminal or device 208.

The extracted user or consumer's information (e.g., user's identification, user's account information, user's mobile communication device information, etc.) and information corresponding to the sales transaction (e.g., price, description of goods/services, etc.) are stored as one or more entries in a database 209. Various merchants may send promotional offer information to the server 210, whereby the promotional offer information is also stored as one or more database entries in a database 211.

In some implementations, the extracted user or consumer's information and information corresponding to the sales transaction are, for example, stored in a separate transaction database, while the promotional offer information may be stored in a promotional offer database. In other implementations, the extracted user or consumer's information, the information corresponding to the sales transaction, and the promotional offer information may be stored in a single database. In implementations utilizing more than one database, the databases may be distributed over a communication network and accessed by one or more servers.

By accessing the transaction database, the user or consumer's stored information and corresponding sales transaction information are accessed, compared, and correlated with any existing stored promotional offers retrieved from the promotional offer database 212. The corresponding sales transaction information may provide, among other things, information regarding the goods or services purchased by the consumer. For example, when the user or consumer purchased, for example, an Apple iPad™ device, entries in the promotional offer database may be searched for offers that correspond to electronic computational devices that are similar to the user or consumer's previously purchased Apple iPad™ (e.g., tablet computers). Alternatively or additionally, entries in the promotional offer database may be searched for offers that correspond to the same or a similar manufacturer (i.e., Apple™) as that of the product purchased (i.e., Apple iPad™). For example, offers corresponding to Apple™ products (e.g., iPod Touch, iPhone, MacBook Pro., etc.) may be searched and retrieved from the promotional offer database. In one embodiment, since the PDR comparison may involve several database tables, the PDR may join several tables (e.g., 1019a, 1019b, 1019c, and 1019f), resulting in a joined consumer aggregation table, which may be queried.

According to one implementation, the promotional offer database may be searched for correlating offers that correspond to purchases that are very similar (e.g., similar device type) to the user or consumer's previously purchased goods or services. According to another implementation, the promotional offer database may be searched for correlating offers that correspond to purchases that are similar in category (e.g., electronic goods) to the user or consumer's previously purchased goods or services. According to yet another implementation, the promotional offer database may be searched for correlating offers that correspond to purchases that are associated with a particular manufacturer of good (e.g., Apple™) from which the user or consumer previously purchased goods or services. Further, other implementations may incorporate various combinations of correlation rules, whereby, for example, the promotional offer database may be searched for correlating both: (1) offers that correspond to purchases that are associated with a particular manufacturer of good (e.g., Apple™) from which the user or consumer previously purchased goods or services; and (2) offers that correspond to purchases (i.e., goods or services) that are similar in category and/or device type to the user or consumer's previously purchased goods or services.

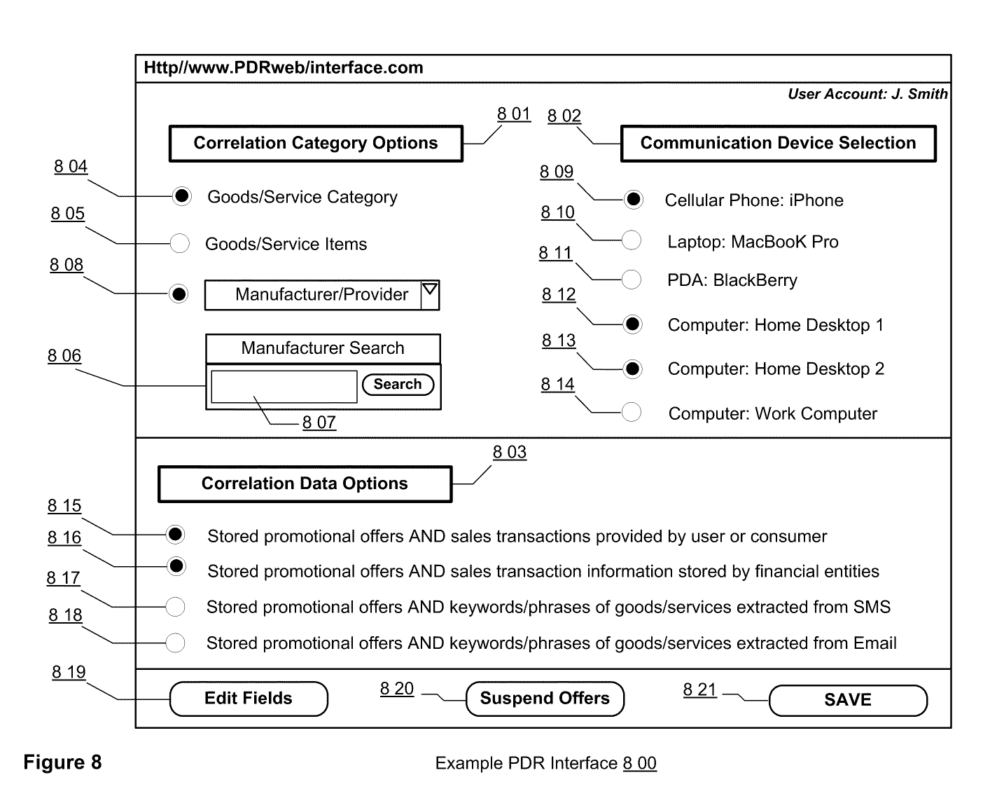

Some implementations may provide a user or consumer with the ability to specify one or more rules for correlating and selecting offers for the user or consumer via a web-interface (e.g., see FIG. 8). Other implementations may adopt a dynamic mechanism by which different correlation rules are executed based on the volume of offers that are located in the promotional offer database. For example, initially, the promotional offer database may be searched (i.e., via a server computer) for correlating offers that correspond to purchases that are similar in category (e.g., electronic goods) to the user or consumer's previously purchased goods or services. If this search produces a list of offers that exceeds a particular threshold (e.g., 20 offers), a different correlation rule may be used whereby, for example, the promotional offer database may be searched for correlating offers that correspond to purchases that are very similar (e.g., similar device type) to the user or consumer's previously purchased goods or services. By changing the correlation rule, a more target number of offers (e.g., 1-5 offers) may be presented to the user or consumer. This feature may, however, be overridden by a user or consumer via a web-interface (e.g., see FIG. 8) that permits the user or consumer to customize the correlation rules and manner in which the offers are presented.

Other implementations may adopt a dynamic feedback mechanism by utilizing purchase-offer-feedback information from the system. Purchase-offer-feedback information may involve identifying stored user or consumer purchases (i.e., within the transaction database) that were made in response to promotional offers that were presented to the user or consumer by the PDR system. By analyzing the stored purchase-offer-feedback information, it may be established whether the user or consumer desires purchase-interests in targeted offers of a more narrow focus or targeted offers of a more broad nature. Based on this analysis, future targeted offers may be dynamically adapted to change their relative focus in relation to the user or consumer's response (i.e., purchase or ignore) to previously presented promotional offers.

For example, the user or consumer's purchase of goods and/or services that correspond to received promotional offers may indicate if the user or consumer is more interested in goods and/or services that correspond to purchases that are very similar to (e.g., same/similar to a particular device category) the user or consumer's previously purchased goods or services. This would indicate a more narrow focus illustrating the user or consumer's desire to receive offers that are very similar to, or the same as, the user or consumer's previous purchases (e.g., Cameras: Camera Bodies, Camera Accessories, Camera Lenses, Photography Software, etc.). According to another example, the user or consumer's purchase of goods and/or services that correspond to received promotional offers may indicate if the user or consumer is more interested in goods and/or services that correspond to purchases that are more generally (e.g., similar goods category) related to the user or consumer's previously purchased goods or services. This would indicate a more broad focus illustrating the user or consumer's desire to receive offers that are generally related the user or consumer's previous purchases (e.g., electronic equipment: TVs, MP3 Players, Laptop Computers, etc.).

Based on the correlation described above 212, once a promotional offer or offers for a particular user or consumer has been identified, the offer or offers are then sent, via an appropriate channel (e.g., Email, SMS, mobile application, etc.), to the user or consumer 213 at either the merchant location where the user or consumer is making a purchase 214 or to a designated mobile communication device (i.e., executing a mobile app) associated with the user or consumer 215. For example, a multimodal gateway may be used to send Email, SMS, MMS, or other message formats to the user or consumer based on the user or consumer's preferences (e.g., SMS message preference). When the offer or offers are sent to the user or consumer 213 at the merchant location, the offer or offers may be, for example, printed on the same medium as the user or consumer's receipt. Alternatively, the offer or offers may be, for example, printed on a separate medium (e.g., paper) as the user or consumer's receipt. The offer or offers may also be, for example, provided by the merchant (e.g., cashier) to the purchasing user or consumer as store credit, a discount voucher, or any other promotional means adopted by the merchant.

As previously described, the promotional offer or offers provided to the designated mobile communication device associated with the user or consumer 215 may be in the form of, for example, an attached or downloadable PDF document, one or more barcodes that may be displayed on the mobile communication device, a promotional code that includes a description of the particular promotion (e.g., Code: 4eRFT34X; 40% off all laptop computers), and/or at least one hyperlink that the may be used to navigate the user or consumer to promotional offer information at a website.

In accordance with another implementation, other information may be generated by comparing and correlating the user or consumer's stored information, information corresponding to sales transactions, and stored offers. For example, by parsing the user or consumer's stored information and/or information corresponding to sales transactions, information associated with fraud detection may be generated and presented to a user or consumer for verification purposes. For instance, based on parsing a user or consumer's transaction information involving a cell phone, the user or consumer may be prompted with a security question such as “what is the model of your cell phone purchase of Apr. 12, 2011?” Thus, fraud-protection capabilities (e.g., generated security questions) may be dynamically updated based on the user or consumer's information that is receive and processed by the PDR system. In such an implementation, security may be increased as a result of the PDR system receiving new and additional data. In other implementations, parsing the user or consumer's stored information and/or information corresponding to sales transactions may be utilized to send the user or consumer targeted alerts such as “10% discounts on all hotel rooms between June and August.”

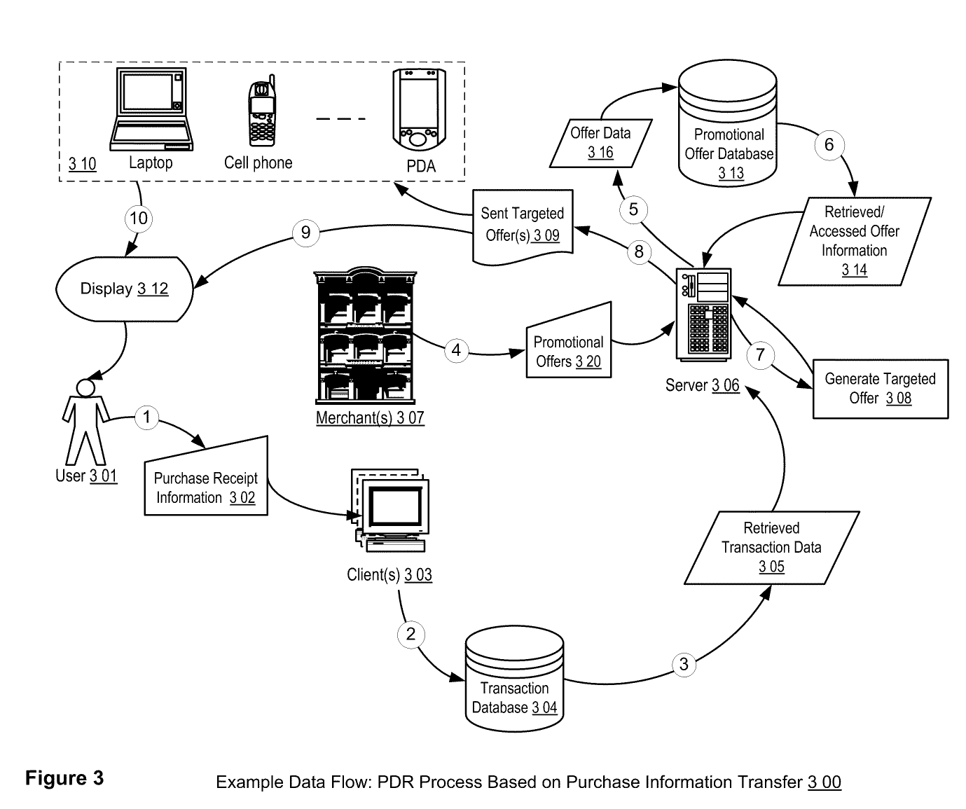

FIG. 3 is of a block diagram 300 illustrating other example aspects of a targeted promotional offer process in some embodiments of the PDR. A user or consumer 301 may desire to send purchase receipt information 302 to a transaction database 304 via a client device 303. In some example aspect, the client device 303 may be a user or consumer's 301 web-enable computer (e.g., laptop, desktop, tablet, etc.) or a mobile communication device (e.g., PDA, smartphone, etc.). The transmitted purchase receipt information 302 is stored in the transaction database 304 along with transaction data associated with various other users or consumers. For example, the transaction database may receive (e.g., via one or more servers) transaction data from different entities such as, for example, issuers (e.g., user or consumer banks), acquirers (e.g., merchant banks), and payment processor institutions (e.g., VISA, MASTERCARD, etc.).

The transaction data may include, but is not limited to, information corresponding to the user or consumer's financial account information. The transaction data may further include information corresponding to sales purchases (e.g., goods or services purchased) such as a description code (e.g., NAICS: North American Industry Classification System) and description associated with the purchased item, cost of the purchased item, and date of transaction. The transaction data may also include information regarding one or more of the user or consumer's mobile communication devices 114 such as, but not limited to, the device name (e.g., Apple iPhone™, Motorola Droid™, etc.), means of communication adopted by each device (e.g., SMS message, Email, etc.), and a user-determinable device preference (e.g., Apple iPhone™ device) for establishing communications.

A server computer 306 may receive 320 and store 316 promotional offer information that correspond to various goods or services from different merchants 307. For example, one merchant promotional offer may include “Merchant X: 20% reduction from the purchase of any laptop computer within the month of April.” According to another example, “Merchant Y: 6-months of free software and hardware support provided for any laptop computer purchased within the month of May.” For example, transmission of merchant promotional offer information between the merchants 307 and the computer server 306 may be in the form of a HTTP POST or GET message. Alternatively, the various merchants 307 may send the merchant promotional offer information to the computer server 306 in the form of an email, SMS message, or via any other communication protocol established between, and supported by, both the merchant 307 and the server 306. The server 306 may store the received merchant promotional offer information in a promotional offer database 313.

The server 306 retrieves or accesses both stored transaction data 305 from the transaction database 304 and stored merchant promotional offer information 314 from the promotional offer database 313. The server 306 then processes the retrieved or accessed transaction data 305 along with the retrieved or accessed merchant promotional offer information 314 in order to generate a targeted promotional offer 308 for each particular user or consumer utilizing the PDR system. For example, when a particular user or consumer's transaction data includes sales information corresponding to the purchase of camera equipment, any merchant promotional offer information corresponding to camera equipment will be identified as a targeted promotion for that particular user or consumer.

The targeted promotional offer is then sent 309 to any predetermined one of the user or consumer's 301 mobile communication devices 310 for display 312. The displayed promotion may be presented in many different forms. For example, the sent offer 309 may include an attached or downloadable PDF document. According to another example, the sent offer 309 may include one or more barcodes that may be displayed on one of the mobile communication devices 310. Thus, at a merchant's business location, the barcode or barcodes displayed by the mobile communication device may be scanned in order to receive a particular discount on the sale of particular goods or services. Alternatively, for example, the displayed targeted promotion may be a promotional code that includes a description of the particular promotion (e.g., Code: 4eRFT34X; 40% off all laptop computers). At a merchant's point-of-sale (POS), the promotional code (e.g., 4eRFT34X) may be submitted when the user is purchasing, for example, a laptop computer.

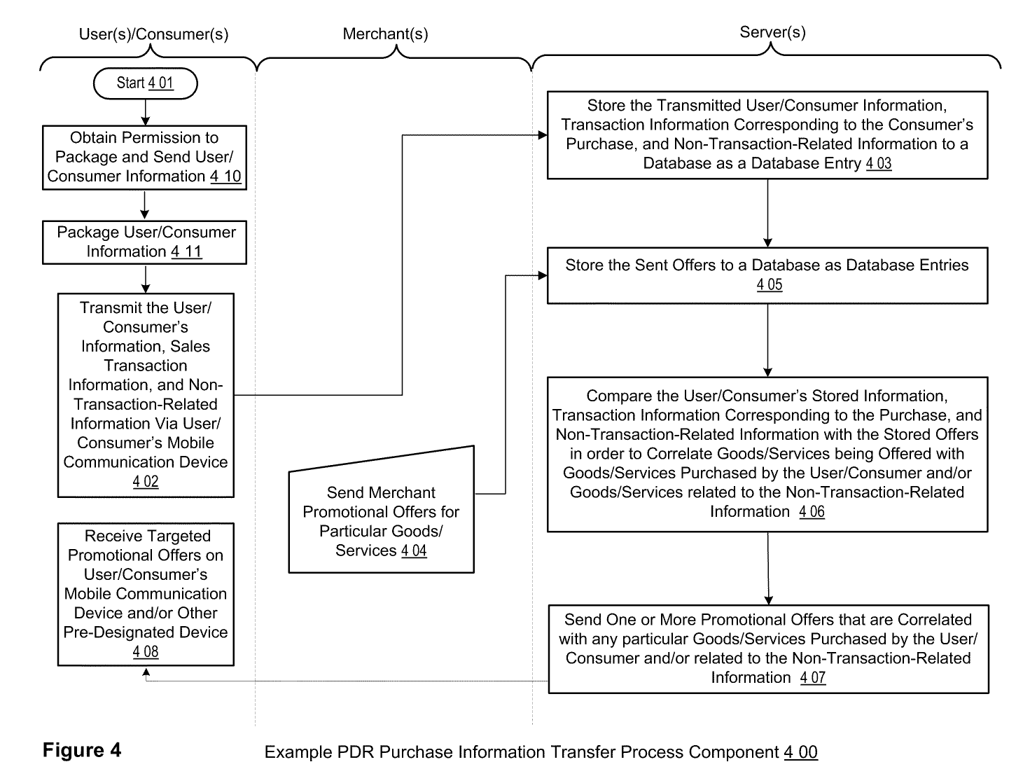

FIG. 4 is of a logic flow diagram 400 illustrating other targeted promotional offer processes 400 according to some embodiments of the PDR. A user or consumer's information, sales transaction information, and non-transaction-related information are transmitted from the user or consumer's mobile communication device to a server computer for processing 402. The user or consumer's information may include, for example, the user's name, the user's address, and a unique identification code associated with the user. The user or consumer's sales transaction information may include, for example, information associated with user's account (e.g., name of user's bank, name of credit card issuing organization), a description or code associated with the purchased item or items (e.g., NAICS code), purchase price or prices, merchant's name, merchant's line of business, geographical location of merchant, and time and date of purchase. The user or consumer's non-transaction-related information may include, for example, information regarding the user or consumer's mobile communication devices such as, but not limited to, a device name (e.g., Apple iPhone™, Motorola Droid™, etc.), a device serial number, means of communication adopted by each device (e.g., SMS message, Email, etc.), and a user-determinable device preference for establishing communications with one or more other mobile communication device's (e.g., Apple iPhone™ and BlackBerry Device) associated with the user or consumer.

Prior to transmitting a user or consumer's information, sales transaction information, and non-transaction-related information from the mobile communication device to a server computer for processing 402, the user or consumer may be required to confirm that permission is given to package and send the user or consumer's information, sales transaction information, and non-transaction-related information to a server of a financial entity 410 (e.g., VISA). For example, in the event that the user or consumer uses a mobile communication device as an e-wallet, an application executing the e-wallet function may request the user or consumer's permission prior to packaging and sending the user or consumer's information, sales transaction information, and non-transaction-related information. Once the user or consumer grants permission, the user or consumer's information, sales transaction information, and non-transaction-related information may be packaged 411 for transmission to the server of the financial entity (e.g., VISA).

At the server, the transmitted user or consumer's information, transaction information, and non-transaction-related information is stored as one or more database entries in a database 403. Also, various merchants may send promotional offer information to the server 404, whereby the promotional offer information is also stored as one or more database entries in a database 405.

In some implementations, the transmitted user or consumer's information, sales transaction information, and non-transaction-related information are, for example, stored in a separate transaction database, while the promotional offer information may be stored in a promotional offer database. In other implementations, transmitted user or consumer's information, transaction information, non-transaction-related information, and the promotional offer information may be stored in a single database. In implementations utilizing more than one database, the databases may be distributed over a communication network and accessed by one or more servers.

By accessing the transaction database, the user or consumer's stored information, sales transaction information, and non-transaction-related information are accessed, compared, and correlated with any existing stored promotional offers retrieved from the promotional offer database 406. As described, the corresponding sales transaction information transmitted from the user or consumer's mobile communication device may provide information regarding the goods or services purchased by the consumer. For example, when the user or consumer transmits their purchase activity (e.g., Apple iPad™ device purchase) for storage in the transaction database, entries in the promotional offer database may be searched for offers that correspond to electronic computational devices that are similar to the user or consumer's previously purchased Apple iPad™ (e.g., tablet computers) transaction. Alternatively or additionally, entries in the promotional offer database may be searched for offers that correspond to the same or a similar manufacturer (i.e., Apple™) as that of the product purchased (i.e., Apple iPad™). For example, offers corresponding to Apple™ products (e.g., iPod Touch, iPhone, MacBook Pro., etc.) may searched and retrieved from the promotional offer database.

According to one implementation, the promotional offer database may be searched for correlating offers that correspond to purchases that are very similar (e.g., similar device type) to the user or consumer's previously purchased goods or services. According to another implementation, the promotional offer database may be searched for correlating offers that correspond to purchases that are similar in category (e.g., electronic goods) to the user or consumer's previously purchased goods or services. According to yet another implementation, the promotional offer database may be searched for correlating offers that correspond to purchases that are associated with a particular manufacturer of good (e.g., Apple™) from which the user or consumer previously purchased goods or services. Further, other implementations may incorporate various combinations of correlation rules, whereby, for example, the promotional offer database may be searched for correlating both: (1) offers that correspond to purchases that are associated with a particular manufacturer of good (e.g., Apple™) from which the user or consumer previously purchased goods or services; and (2) offers that correspond to purchases (i.e., goods or services) that are similar in category and/or device type to the user or consumer's previously purchased goods or services.

Some implementations may provide a user or consumer with the ability to specify (e.g., via a web-interface) one or more rules for correlating and selecting offers for the user or consumer. Other implementations may adopt a dynamic mechanism by which different correlation rules are executed based on the volume of offers that are located in the promotional offer database. For example, initially, the promotional offer database may be searched (i.e., via a server computer) for correlating offers that correspond to purchases that are similar in category (e.g., electronic goods) to the user or consumer's previously purchased goods or services. If this search produces a list of offers that exceeds a particular threshold (e.g., 20 offers), a different correlation rule may be used whereby, for example, the promotional offer database may be searched for correlating offers that correspond to purchases that are very similar (e.g., similar device type) to the user or consumer's previously purchased goods or services. By changing the correlation rule, a more target number of offers (e.g., 1-5 offers) may be presented to the user or consumer. This feature may, however, be overridden by a user or consumer via a web-interface (e.g., see FIG. 8) that permits the user or consumer to customize the correlation rules and manner in which the offers are presented.

Other implementations may adopt a dynamic mechanism by utilizing purchase-offer-feedback information from the system. Purchase-offer-feedback information may involve identifying stored user or consumer purchases (i.e., within the transaction database) that were made in response to promotional offers that were made to the user or consumer. By analyzing the stored purchase-offer-feedback information, it may be established whether the user or consumer has purchase interests in targeted offers of a more narrow focus or targeted offers of a more broad nature. Based on this analysis, future targeted offers may be dynamically adapted to change their relative focus in relation to the user or consumer's response (i.e., purchase or ignore) to previously presented promotional offers.

For example, the user or consumer's purchase of goods and/or services that correspond to received promotional offers may indicate if the user or consumer is more interested in goods and/or services that correspond to purchases that are very similar to (e.g., same/similar to a particular device category) the user or consumer's previously purchased goods or services. This would indicate a more narrow focus illustrating the user or consumer's desire to receive offers that are very similar to, or the same as, the user or consumer's previous purchases (e.g., Cameras: Camera Bodies, Camera Accessories, Camera Lenses, Photography Software, etc.). According to another example, the user or consumer's purchase of goods and/or services that correspond to received promotional offers may indicate if the user or consumer is more interested in goods and/or services that correspond to purchases that are more generally (e.g., similar goods category) related to the user or consumer's previously purchased goods or services. This would indicate a more broad focus illustrating the user or consumer's desire to receive offers that are generally related the user or consumer's previous purchases (e.g., electronic equipment: TVs, MP3 Players, Laptop Computers, etc.).

By providing the user or consumer with the opportunity to transmit their purchase activity to a server 402 for correlation with stored promotional offers 406, the user or consumer is facilitating the provision of sales transaction that are of significance to the user or consumer. This in turn provides an increased targeting of offers, whereby the promotional offers are compared to a list of sales transactions selectively provided by the user or consumer. According to some implementations, the correlation between the stored promotional offers 406 and the user or consumer's transaction data includes the use or both: (1) sales transaction information stored as a result of financial transaction information captured and stored by financial entities such as payment processors (e.g., VISA); and (2) a list of sales transactions selectively provided by the user or consumer.

According to another implementation, the non-transaction-related information may include SMS or other message/media data (e.g., Email, Audio files, Video files, Image files, Tweets, Interactive Chat text, etc.) that is stored within the user or consumer's mobile communication device, whereby the SMS or other message/media data is transmitted, upon user-authorization, from the mobile communication device to one or more server computers 402. The one or more servers may then store the SMS or other message data as database entries in one or more databases for processing 403. Thus, during the correlation process 406, the SMS or other message data corresponding to the user or consumer is parsed in order to extract and determine keywords or phrases that are indicative of goods and/or services. The determined goods and services keywords are then compared and correlated with various database entries 406 associated with the promotional offers sent from various merchants' 404 and stored in a database 405. Also, by sending SMS or other message data from the mobile communication device to one or more server computers for storage in, for example, a database, the user or consumer's message data is retained in the event that the mobile communication device is lost, stolen, or irreparably damaged. In other words, various data associated with the user or consumer is uploaded from an individual mobile device to a secure location on the Cloud. Other data such as video (e.g., MPEG files), Images (e.g., JPEG, TIFF, etc.), and browsing history may be parsed in order to extract and determine keywords or phrases that are indicative of goods and/or services or interest to the user or consumer.

According to one implementation, SMS or other message/media data may be sent to a server of the PDR system (e.g., server 306) by the user or consumer. In such an implementation, the user or consumer may forward SMS or other data such as Email(s) to the server for both storage and the identification (e.g., via parsing of SMS or Email text) of targeted promotional offers. Since the user or consumer is forwarding their own personal data (e.g., SMS), there is an assumption that any such received data by the server has been authorized by the user or consumer. According to another implementation, email may be sent to an Email server via simple mail transfer protocol (SMTP), whereby the email messages, upon receiving a user or consumer authorization prompt, are sent to a server, e.g., 106, for processing.

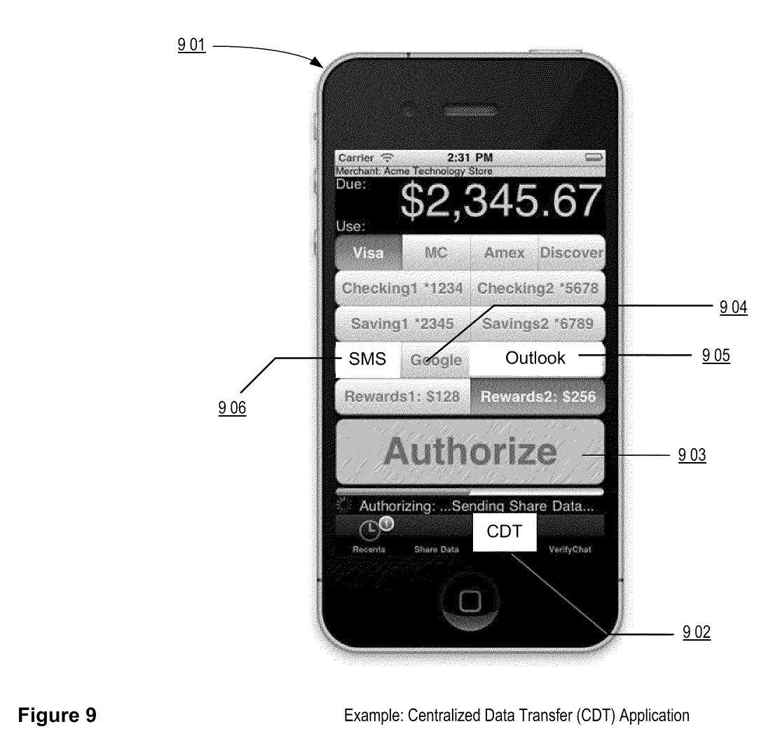

According to yet another implementation, SMS or other message data may be managed, packaged, and transmitted to the server by an application program executing on the user or consumer's mobile communication device. An example of such an application executing on a mobile communication device 901 is illustrated in FIG. 9. A centralized data transfer (CDT) application 902 prompts the user or consumer of the mobile communication device 901 for authorization prior to packaging and sending any SMS or other message data to the server. For example, in order for the mobile communication device 901 to package and send any SMS or other message data, the user or consumer may be required to press an Authorize button 903. In some aspects, the CDT application 902 may be authorized to package and send message data from one or more pre-designated applications executing on the user or consumer's mobile communication device 901. Such pre-designated applications may include, for example, a Google™ Email application 904, a Microsoft Outlook Email application 905, and a SMS application 906. The pre-designated applications may only provide messaging data to the CDT application 902 based on a prearranged agreement, whereby the manufacturer's of the pre-designated applications assign the CDT application 902 as a trusted application program for receiving messaging data. Also, as previously described, once the CDT application 902 has packaged the SMS and/or messaging data that has been received from the pre-designated applications, e.g., 904-906, the user or consumer is required to activate the Authorize button 903 on mobile communication device 901 prior to transmission of the SMS and/or messaging data to the server. The above measures thus provide a layer of security to the user or consumer's content within the SMS and/or messaging data. According to one implementation, the CDT application 902 may package and send the SMS and/or messaging data in their original file formats. According to another implementation, the CDT application 902 may parse keywords and phrases from the SMS and/or messaging data received from the pre-designated applications, e.g., 904-906. The parsed keywords and phrases are then repackaged by the CDT application 902 and send (i.e., upon user/consumer authorization) from the mobile communication device 901 to the server for correlation with other promotional offer data.

According to some implementations, a web-interface (e.g., see FIG. 8) may permit the user or consumer to customize the selectivity of the utilized data prior to generating targeted offers via correlation. For example, the user or consumer may select one of: (1) a correlation between the stored promotional offers and a list of sales transactions selectively provided by the user or consumer; (2) a correlation between the stored promotional offers and sales transaction information stored as a result of financial transaction information captured and stored by financial entities such as payment processors (e.g., VISA); (3) a correlation between the stored promotional offers, sales transaction information stored as a result of financial transaction information captured and stored by financial entities such as payment processors, and a list of sales transactions selectively provided by the user or consumer; or (4) any of the above data selectivity options (i.e., (1), (2), or (3)) including keywords or phrases indicative of goods and/or services that have been extracted from the user or consumer's SMS or other message data corresponding to the user or consumer is parsed in order to determine.

Based on the correlation processes described above 406, once a promotional offer or offers for a particular user or consumer has been identified, the offer or offers are then sent 407 to the user or consumer's designated mobile communication device 408. As previously described, the promotional offer or offers provided to the designated mobile communication device associated with the user or consumer 215 may be in the form of, for example, an attached or downloadable PDF document, one or more barcodes that may be displayed on the mobile communication device, a promotional code that includes a description of the particular promotion (e.g., Code: 4eRFT34X; 40% off all laptop computers), at least one hyperlink that the may be used to navigate the user or consumer to promotional offer information at a website, or any other suitable format.

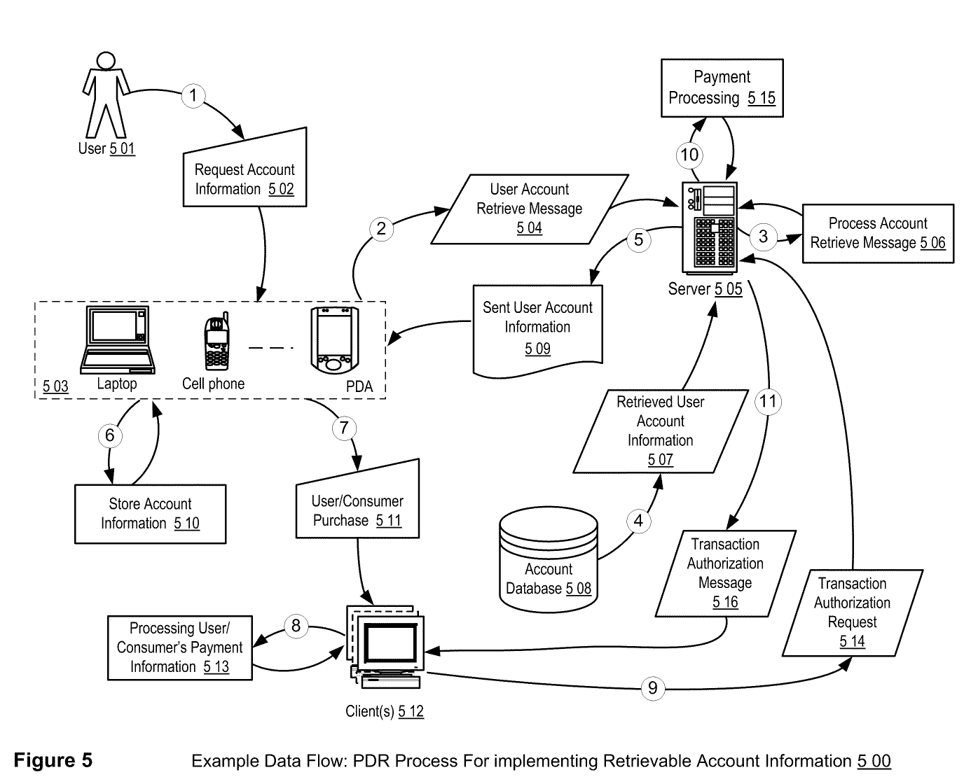

FIG. 5 is of a block diagram 500 illustrating example aspects of a retrievable account information process in some embodiments of the PDR. A user or consumer 501 may request their financial account information 502 (e.g., VISA credit-card account information, American Express™ Card information, etc.) using one of their mobile communication devices 503. Using one of the user or consumer's mobile communication devices 503, a user-account-retrieve message 504 is sent to a computer server 505 for processing 506. Based on the processing 506 of the user-account-retrieve message 504, the server 505 retrieves the user or consumer's account information 507 from a secure database 508 that may utilize encryption (e.g., full-database level encryption, file-level encryption options, etc.).

The server 505 sends the retrieved user or consumer's account information 509 to one of the user or consumer's mobile communication devices 503 from which the initial account retrieve message 504 originated. The received account information is securely stored (e.g., encryption hardware/software) within the user or consumer's mobile communication device 510 in order to provide the mobile communication device with the capability to perform POS sale transactions at a merchant's place of business.

The user or consumer 501 may desire to make a sales purchase by providing payment information (e.g., bank account or credit card data) 511 (similar to 102), via their mobile communication device (e.g., using VISA payWave™), to a client device 512 such as a merchant's point-of-sale (POS) terminal. The client device 512 processes the user or consumer's payment information received from the mobile communication device 513 and transmits this payment information in the form of a transaction authorization request 514 to the server 505. The server 505 may then facilitate a payment transaction process 515 with several other financial entities (not shown) such as, for example, an issuer (e.g., user's bank), an acquirer (e.g., merchant's bank), and a payment processor institution (e.g., VISA). Upon processing of the user or consumer's transaction request 515, the server receives a “transaction authorized” or a “transaction denied” message from one of the financial entities (e.g., VISA). The server may then send the received “transaction authorized” or a “transaction denied” message 516 to the client 512 and/or POS terminal in order to inform the consumer and merchant as to the status of the sale transaction.

The above-described PDR process may generate a request for retrieving user or consumer account information, e.g., 504, whereby, for example, the server, e.g., 505, may receive a HTTP(S) POST request similar to the example below:

```
POST /requestpromtions.php HTTP/1.1
Host: www.PDRprocess.com
Content-Type: Application/XML
Content-Length: 788
<?XML version = “1.0” encoding = “UTF-8”?>
<UserAccountRetrieve_request>
<timestamp>2011-02-22 17:00:01</timestamp>
  <user_information>
    <user_name>John Smith</use_name>
    <user_address>John Smith</user_address>
    <account_type>credit</account_type>
    <account_issuer>123Bank</account_issuer>
    <account_payment_processor>VISA</
    account_payment_processor>
  </user_information>
  <user_security>
    <user_encrypted_passcode>$$$$$$$$</user_encrypted_passcode>
    <user_encryption>digital certificate 1</user_encryption>
    <user_SSN>XXX-XX-XXXX</user_SSN>
    <user_security_question>what was the name of your elementary
    school?</user_security_question>
  </user_security>
  <user_merchant_preferences>
    <merchant_id>3FBCR4INC</merchant_id>
    <merchant_name>Apple Store</merchant_name>
    <merchant_Industry>electronic goods</merchant_industry>
    <merchant_Location>Manhattan 10022</merchant_Location>
  </user_merchant_preferences>
  <user_message_data>
    <message_source1>Email</message_source1>
    <message_source2>SMS</message_source2>
    <message_source3>MMS</message_source2>
    <message_source_preference>SMS</message_source_preference>
    <Media_data1>MPEG files</Media_data1>
    <Media_data_source>www.youtube.com</Media_data_source>
    <user_hyperlinks>www.guitarcenter.com</user_hyperlinks>
  </user_message_data>
  <user_device_type>
    <user_device1>smartphone</user_device1>
    <user_device2>laptop</user_device2>
    <user_device3>PDA</user_device3>
    <user_device_preference>smartphone</user_device_preference>
  </user_device_type>
</UserAccountRetrieve_request>
```

As illustrated by the above HTTP(S) POST request, in addition to requesting the retrieval of the user or consumer's account information, other information may also be included in the POST command. For example, information associated with the user or consumer's security (e.g., an encrypted passcode for retrieving the user or consumer's account information), the user or consumer's preferred merchants, the user or consumer's message data (e.g., Emails, SMS, MMS, visited website hyperlinks, etc.), and the user or consumer's preferred mobile communication device(s) for communication (e.g., user's smartphone) may also be sent to the server, e.g., 505, and then stored for subsequent processing and generation of targeted information (e.g., promotional offers, alerts, fraud protection, etc.).

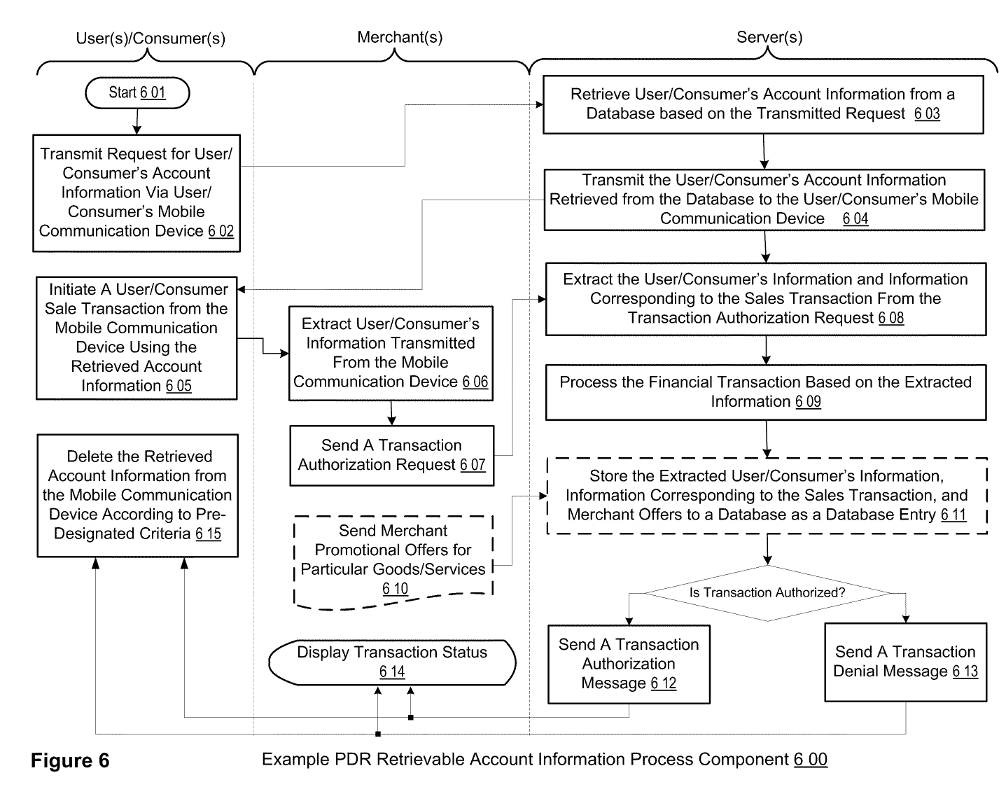

FIG. 6 is of a logic flow diagram 600 illustrating a retrievable account information process in some embodiments of the PDR. A request for a user or consumer's financial account information is transmitted from the user or consumer's mobile communication device to a server 602. The server retrieves the user or consumer's account information from a database, whereby the database may utilize suitable encryption schemes for ensuring the security of any stored account information 603. Once retrieved from the database, the user or consumer's account information is transmitted from the server and securely stored within the user or consumer's mobile communication device 604.

The user or consumer may initiate a sale transaction using the mobile communication device, whereby the mobile communication device transmits the user or consumer's account information to a merchant's POS during the purchase of particular goods and/or services 605. At the merchant's business location, the merchant's POS terminal extracts the transmitted user or consumer account information received from the mobile communication device 606 (e.g., received via wireless transmission). The extracted account information is utilized by the POS terminal to generate a transaction authorization request 607, which is sent to the server for processing. At the server, the user or consumer's information (e.g., user's identification, user's account information, user's mobile communication device information, etc.) and information corresponding to the sales transaction (e.g., price, description of goods/services, etc.) is extracted from the transaction authorization request 608.

In conjunction with computer servers of several other financial entities (e.g., user's issuer bank, merchant's acquirer bank, etc.), the information extracted from the transaction authorization request (e.g., user's account information and purchase information) is processed 609. The extracted user or consumer's information (e.g., user's identification, user's account information, user's mobile communication device information, etc.) and information corresponding to the sales transaction (e.g., price, description of goods/services, etc.) are also stored as one or more entries in a database 611. Various merchants may also send promotional offer information to the server 610, whereby the promotional offer information is also stored as one or more database entries in a database 611.

Based on the financial transaction processing 609, it is determined whether the transaction is authorized, whereby the user or consumer is notified as to the status of the initiated sales transaction. Thus, the user or consumer receives either a transaction-authorization message 612 or a transaction-denial message 613, either of which are displayed at the merchant's POS terminal or device 614.

As a security measure, once it is determined whether the transaction is denied or authorized, the user or consumer's account information may be deleted from the mobile communication device 615. This facilitates a means from protecting the user or consumer's account information, which may arise as a result of the user or consumer loosing or having their mobile communication device stolen. Also, by limiting the time duration over which the account information is loaded onto the mobile communication device, potential security breaches that may arise from hackers are reduced or neutralized. According to one implementation, an application executing on the mobile communication device may manage requests, secure storage, and deletion of the user or consumer's account information. In other implementations, the user or consumer's account information may be stored in an encrypted format within a tamper-proof memory device of the mobile communication device. In such an implementation, there is no requisite need for deleting the account information after either a lapse of a time duration (e.g., 60 minutes) or based on the financial transaction (e.g., receiving a status notification: “Authorized” or “Denied”).

In some implementations, the extracted user or consumer's information and information corresponding to the sales transaction are, for example, stored in a separate transaction database, while the promotional offer information may be stored in a promotional offer database. In other implementations, the extracted user or consumer's information, the information corresponding to the sales transaction, and the promotional offer information may be stored in a single database. In implementations utilizing more than one database, the databases may be distributed over a communication network and accessed by one or more servers.

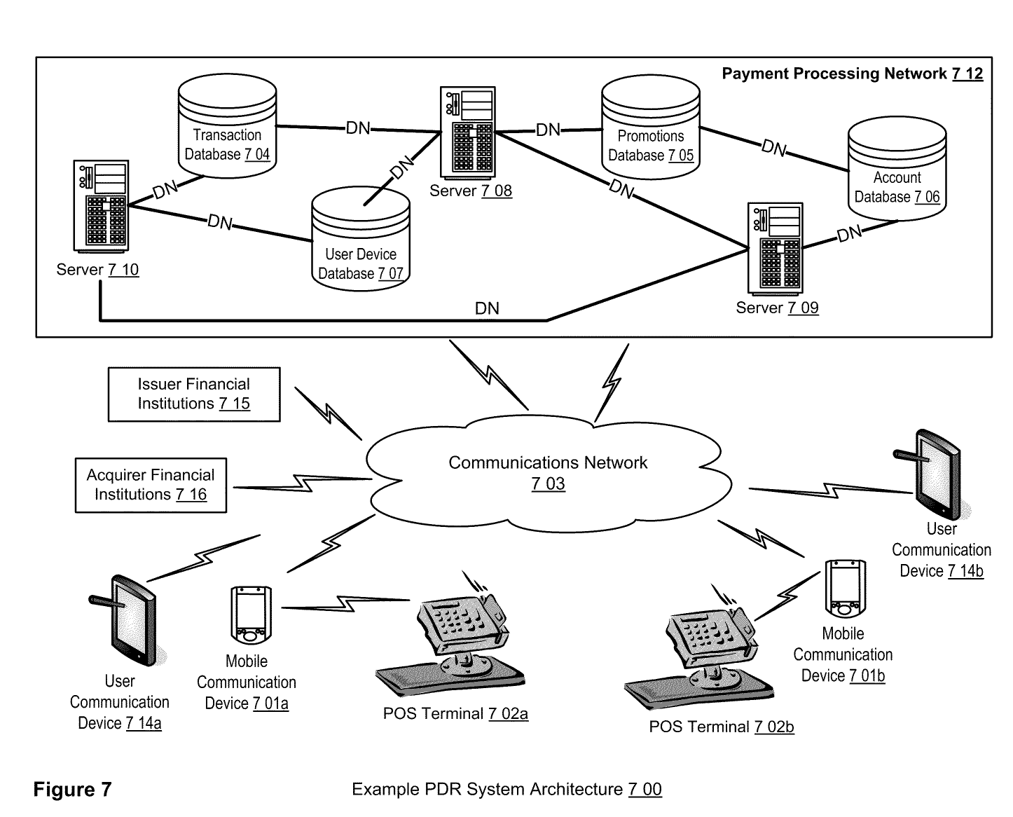

FIG. 7 is of a block diagram 700 illustrating example system architecture aspects of some embodiments of the PDR. The various implementations and aspects described in relation to FIGS. 1-6 may be implemented within the system illustrated in FIG. 7. The exemplary PDR system 700 may include a plurality of user mobile communication devices 701a-701b, a plurality of user communication devices 714a-714b, a plurality of merchant POS terminals 702a-702b, issuer financial institutions 715, acquirer financial institutions 716, and a financial payment processing network 712, all of which may communicate over a communications network 703.

The payment processing network 712 (e.g., VisaNet™) may include a plurality of server computers 708-710 and a plurality of databases 704-707, which are in communication with each other either via a dedicated network (DN) or the communication network 703. For example, sale transaction related data may be stored in transaction database 704, merchant promotional offer data may be stored in promotions database 705, user or consumer financial account data may be stored in account database 706, and data associated with mobile communication devices or user communication devices may be stored in user device database 707. Although each of the databases 704-707 are illustrated as separate entities, one or more of these databases may be incorporated into a single database. The server computers 708-710 access and retrieve data from the various databases 704-707 for processing, whereby each server may be utilized on a load sharing basis. For example, if server 710 is executing, for example, a PDR purchase activity process (see FIG. 2) and unable to handle additional processing requests on behalf of other user or consumer's, server 710 may assign the additional PDR purchase activity processes for the other user or consumer's to either or both servers 708 and 709.

Since the payment processing network 712 has access to, manages, and stores user or consumer-related sale transactions, a platform for providing a vast amount of purchase data is available for correlation with merchant-provided promotional offer data. Thus, the payment processing network 712 facilitates the processing and distribution of targeted promotional offers to the individual user or consumers based on their purchase activities. The targeted promotional offers are distributed to one or more of the individual user or consumer's user mobile communication devices 701a-701b and/or one or more of the individual user or consumer's plurality of user communication devices 714a-714b. As previously described, certain correlation rules and distribution means may be customized by the individual user or consumers using, for example, a server-based PDR interface application program that presents user or consumers with a web-interface (e.g., see FIG. 8). Such a web-interface may be generated by executing the PDR interface application program on any one or more of the server computers 708-710.

FIG. 8 illustrates an example of a web-interface 800 presented to a user or consumer according to some embodiments of the PDR. The web-interface 800 may include several selectable options that provide the user or consumer with the opportunity to customize the manner in which the targeted promotional offers are processed, selected, and delivered. For example, the selectable options include Correlation Category Options 801, Communication Device Selection 802, and Correlation Data Options 803.

The Correlation Category Options 801 provide the user or consumer with the opportunity to select the focus (e.g., narrower or broader) of the search and correlation process that matches the user or consumer's prior purchase activities with existing merchant promotional offers. The selectable categories are a Goods/Services Category 804, Goods/Services Items 805, and a Manufacturer/Service-Provider pull down menu 808 and Search option 806. For example, the Goods/Services Category 804 applies to a more general correlation of promotional offers of a particular category (e.g., computer flat screen monitor sale up to 30%) to user or consumer purchases of the same or a similar category (e.g., laptop computer purchase). On the other hand, the Goods/Services Items 805 option applies to a narrower correlation of promotional offers corresponding to particular items (e.g., laptop 50% sale) to user or consumer purchases of the same or a similar category (e.g., desktop computer and laptop computer purchases). The user or consumer may also desire a correlation of promotional offers for a particular manufacturer or service provider by electing a manufacturer/service provider selection from the pull-down menu 808. If the particular manufacturer or service provider is not listed in the pull-down menu 808, the user or consumer may search for their manufacturer of choice via the Search option 806 by typing the manufacturer's name in the search field 807.

Within the Correlation Category Options 801, the user or consumer may select any one or more selectable options. For example, as illustrated, the Account holder (i.e., J. Smith) has selected the Goods/Service Category 804 and the Manufacturer/Provider 808 options.

The Communication Device Selection option 802 provides a list of communication devices that correspond to the individual user or consumer. Once the targeted promotional offers have been determined, the user or consumer may elect to receive these offers by selecting from this list one or more communication devices such as, but not limited to, a Cellular Phone (e.g., iPhone) option 809, a Laptop (e.g., MacBook Pro) option 810, a PDA (e.g., BlackBerry) option 811, a first Computer (e.g., Home Desktop 1) option 812, a second Computer (e.g., Home Desktop 2) option 813, and a third Computer (e.g., Work Computer) option 814. By selecting one or more of these devices, the determined promotional offers are thus only sent to the selected communication devices. For example, account holder J. Smith has selected his iPhone option 809, Home Desk Top 1 option 812, and Home Desktop 2 option 813 for receiving target promotional offers. Once promotional offers are generated for J. Smith, these offers will be distributed to J. Smith's iPhone, Home Desk Top 1, and Home Desk Top 2 devices.

The Correlation Data Options 803 provide user or consumer selectable options for determining the data that is correlated in order to generate targeted offers. The user or consumer selectable options may include “Stored promotional offers AND sales transactions provided by user or consumer 815,” “Stored promotional offers AND sales transactions stored by financial entries 816,” “Stored promotional offers AND keywords/phrases of goods/services extracted from SMS 817,” and “Stored promotional offers AND keywords/phrases of goods/services extracted from Email 818.” The user or consumer may select any one or more of these options. For example, account holder J. Smith has selected both the “Stored promotional offers AND sales transactions provided by user or consumer 815,” and the “Stored promotional offers AND sales transactions stored by financial entities 816” options.

In order for the user or consumer to customize the manner in which the targeted promotional offers are processed (e.g., Correlation Options), selected (e.g., Goods/Services Items or Category), and delivered (e.g., Device Selection) using the presented web-interface, an Edit Fields button 819 is activated. By, for example, left-clicking (e.g., via a computer mouse) on the Edit Fields button 819, the user or consumer is able to toggle and select the various options within the interface page 800. By, for example, left-clicking on the SAVE button 821, the user or consumer's various selected options on the interface 800 are saved to the PDR system for operation. By, for example, left-clicking on the Suspend Offers button 820, the PDR system suspends providing the user or consumer with promotional targeted offers until which time the user or consumer enters their account (e.g., via a login process) and toggles the Suspend Offers button 820. For example, when the Suspend Offers button 820 is pressed in order to suspend the receipt of promotional offers, the Suspend Offers button 820 may be changed to another button having a different color (e.g., red) and labeled “Activate Offers.” When this button is subsequently pressed to activate receiving promotional offers, the Activate Offers button (not shown) changes back to the Suspend Offers button 820. Alternatively, the interface may have both a Suspend Offers button 820 and an Activate Offers button (not shown).

An exemplary query, written substantially in the form of Python/PHP/SQL commands, to store the web-interface 800 (FIG. 8) settings to the PDR database, is provided below:

<?PHP
header(‘Content-Type: text/plain’);
mysql_connect(“www.PDRprocess.com”,$DBserver,$password); // access database
server
mysql_select(“UI_Table.SQL”); // select database to append
mysql_query(“INSERT INTO UITable (goods_service_category_UI_setting_Bool,
goods_service_items_UI_setting_Bool, manufacturer_provider_UI_setting_Bool,
manufacturer_provider_search_UI_setting_Bool, cellular_device_UI_setting_Bool,
laptop_device_UI_setting_Bool, PDA_device_UI_setting_Bool,
home_computer1_UI_setting_Bool, home_computer2_UI_setting_Bool,
work_computer_UI_setting_Bool,
PromotionalOffer_AND_ConsumerTransactionData_UI_setting_Bool,
PromotionalOffer_AND_SalesTransactionData_UI_setting_Bool,
PromotionalOffer_AND_SMSData_UI_setting_Bool,
PromotionalOffer_AND_EmailData_UI_setting_Bool”)
VALUES (time( ),$goods_service_category_UI_setting_Bool,
$goods_service_items_UI_setting_Bool, $manufacturer_provider_UI_setting_Bool,
$manufacturer_provider_search_UI_setting_Bool,
$cellular_device_UI_setting_Bool, $laptop_device_UI_setting_Bool,
$PDA_device_UI_setting_Bool, $home_computer1_UI_setting_Bool,
$home_computer2_UI_setting_Bool, $work_computer_UI_setting_Bool,
$PromotionalOffer_AND_ConsumerTransactionData_UI_setting_Bool,
$PromotionalOffer_AND_SalesTransactionData_UI_setting_Bool,
$PromotionalOffer_AND_SMSData_UI_setting_Bool,
$PromotionalOffer_AND_EmailData_UI_setting_Bool); // add data to table in
database
mysql_close(“UI_Table.SQL”); // close connection to database

Based on which of the above Boolean settings are set to TRUE, (FIG. 8: checked radio boxes), the PDR may then generate a query based on the set Boolean values (i.e., TRUE or FALSE). As such, an exemplary query, written substantially in the form of Python/PHP/SQL commands, to generate the web-interface 800 settings (see FIG. 8) is provided below:

mysql_connect(“www.PDRprocess.com”,$app_type,$DBserver,$password); // access
server
mysql_select(“joined_consumer_aggregation_table.SQL”); // select database to
search
$query = “SELECT eval_rules FROM joined_consumer_aggregation_table”;
$result = mysql_query($goods_service_category AND $manufacturer_provider AND
$cellular_device AND $home_computer1 AND $home_computer2 AND
$PromotionalOffer_AND_ConsumerTransactionData AND
$PromotionalOffer_AND_SalesTransactionData);//perform the search query
mysql_close(“joined_consumer_aggregation_table.SQL”)//close database access

### PDR Controller

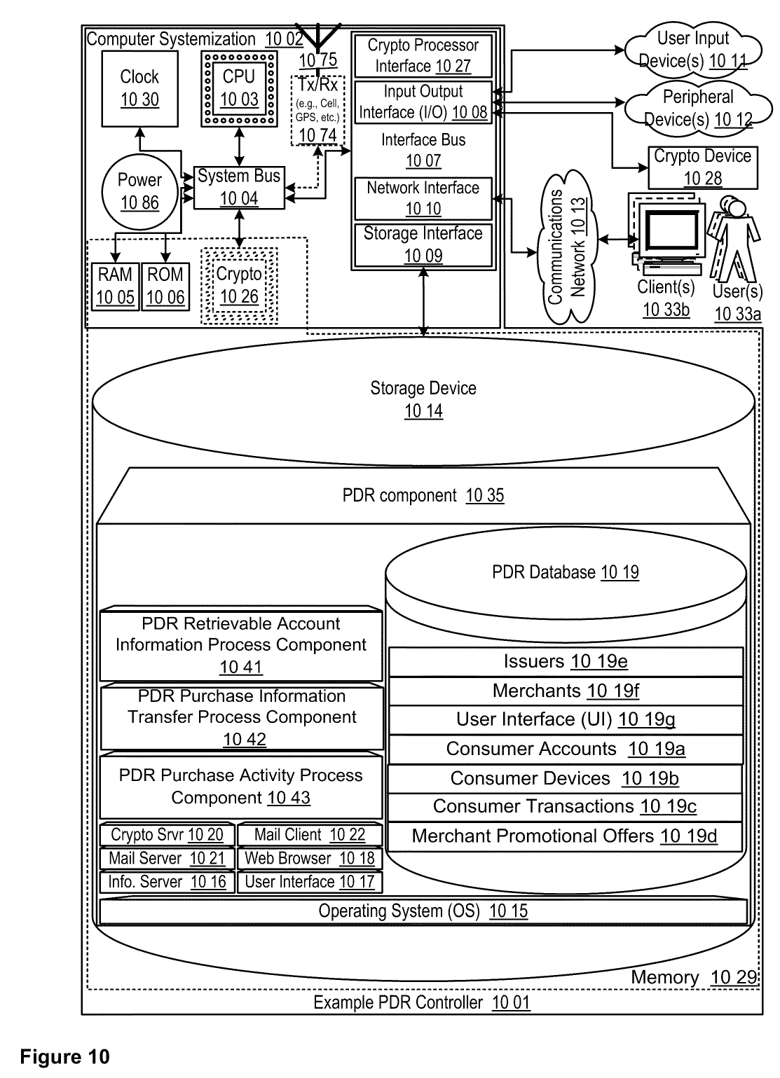

FIG. 10 illustrates inventive aspects of a PDR controller 1001 in a block diagram. In this embodiment, the PDR controller 1001 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 1003 may be referred to as central processing units (CPU). One form of processor is referred to as a microprocessor. CPUs use communicative circuits to pass binary encoded signals acting as instructions to provide various operations. These instructions may be operational and/or data instructions containing and/or referencing other instructions and data in various processor accessible and operable areas of memory 1029 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the PDR controller 1001 may be connected to and/or communicate with entities such as, but not limited to: one or more users from user input devices loll; peripheral devices 1012; an optional cryptographic processor device 1028; and/or a communications network 1013.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The PDR controller 1001 may be based on computer systems that may comprise, but are not limited to, components such as: a computer systemization 1002 connected to memory 1029.

### Computer Systemization

A computer systemization 1002 may comprise a clock 1030, central processing unit (“CPU(s)” and/or “processor(s)” (these terms are used interchangeable throughout the disclosure unless noted to the contrary)) 1003, a memory 1029 (e.g., a read only memory (ROM) 1006, a random access memory (RAM) 1005, etc.), and/or an interface bus 1007, and most frequently, although not necessarily, are all interconnected and/or communicating through a system bus 1004 on one or more (mother)board(s) 1002 having conductive and/or otherwise transportive circuit pathways through which instructions (e.g., binary encoded signals) may travel to effect communications, operations, storage, etc. Optionally, the computer systemization may be connected to an internal power source 1086. Optionally, a cryptographic processor 1026 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1029 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the PDR controller and beyond through various interfaces. Should processing requirements dictate a greater amount speed and/or capacity, distributed processors (e.g., Distributed PDR), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the PDR may be achieved by implementing a microcontroller such as CAST's R8051XC2 microcontroller; Intel's MCS 51 (i.e., 8051 microcontroller); and/or the like. Also, to implement certain features of the PDR, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the PDR component collection (distributed or otherwise) and/or features may be implemented via the microprocessor and/or via embedded components; e.g., via ASIC, coprocessor, DSP, FPGA, and/or the like. Alternately, some implementations of the PDR may be implemented with embedded components that are configured and used to achieve a variety of features or signal processing.

Depending on the particular implementation, the embedded components may include software solutions, hardware solutions, and/or some combination of both hardware/software solutions. For example, PDR features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the PDR features. A hierarchy of programmable interconnects allow logic blocks to be interconnected as needed by the PDR system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the PDR may be developed on regular FPGAs and then migrated into a fixed version that more resembles ASIC implementations. Alternate or coordinating implementations may migrate PDR controller features to a final ASIC instead of or in addition to FPGAs. Depending on the implementation all of the aforementioned embedded components and microprocessors may be considered the “CPU” and/or “processor” for the PDR.

### Power Source

The power source 1086 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1086 is connected to at least one of the interconnected subsequent components of the PDR thereby providing an electric current to all subsequent components. In one example, the power source 1086 is connected to the system bus component 1004. In an alternative embodiment, an outside power source 1086 is provided through a connection across the I/O 1008 interface. For example, a USB and/or IEEE 1394 connection carries both data and power across the connection and is therefore a suitable source of power.

### Interface Adapters

Interface bus(ses) 1007 may accept, connect, and/or communicate to a number of interface adapters, conventionally although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1009 may accept, communicate, and/or connect to a number of storage devices such as, but not limited to: storage devices 1014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1010 may accept, communicate, and/or connect to a communications network 1013. Through a communications network 1013, the PDR controller is accessible through remote clients 1033b (e.g., computers with web browsers) by users 1033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed PDR), architectures may similarly be employed to pool, load balance, and/or otherwise increase the communicative bandwidth required by the PDR controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user input devices 1011, peripheral devices 1012, cryptographic processor devices 1028, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1011 may be card readers, dongles, finger print readers, gloves, graphics tablets, joysticks, keyboards, mouse (mice), remote controls, retina readers, trackballs, trackpads, and/or the like.

Peripheral devices 1012 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the PDR controller may be embodied as an embedded, dedicated, and/or monitor-less (i.e., headless) device, wherein access would be provided over a network interface connection.

Cryptographic units such as, but not limited to, microcontrollers, processors 1026, interfaces 1027, and/or devices 1028 may be attached, and/or communicate with the PDR controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1029. However, memory is a fungible technology and resource, thus, any number of memory embodiments may be employed in lieu of or in concert with one another. It is to be understood that the PDR controller and/or a computer systemization may employ various forms of memory 1029. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1029 will include ROM 1006, RAM 1005, and a storage device 1014. A storage device 1014 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1029 may contain a collection of program and/or database components and/or data such as, but not limited to: operating system component(s) 1015 (operating system); information server component(s) 1016 (information server); user interface component(s) 1017 (user interface); Web browser component(s) 1018 (Web browser); database(s) 1019; mail server component(s) 1021; mail client component(s) 1022; cryptographic server component(s) 1020 (cryptographic server); PDR retrievable account information process component(s) 1041; PDR purchase information transfer process component(s) 1042; PDR purchase activity process component(s) 1043; the PDR component(s) 1035; and/or the like (i.e., collectively a component collection). These components may be stored and accessed from the storage devices and/or from storage devices accessible through an interface bus. Although non-conventional program components such as those in the component collection, typically, are stored in a local storage device 1014, they may also be loaded and/or stored in memory such as: peripheral devices, RAM, remote storage facilities through a communications network, ROM, various forms of memory, and/or the like.

### Operating System

The operating system component 1015 is an executable program component facilitating the operation of the PDR controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with communications networks, data, I/O, peripheral devices, program components, memory, user input devices, and/or the like. The operating system may provide communications protocols that allow the PDR controller to communicate with other entities through a communications network 1013. Various communication protocols may be used by the PDR controller as a subcarrier transport mechanism for interaction, such as, but not limited to: multicast, TCP/IP, UDP, unicast, and/or the like.

### Information Server

An information server component 1016 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the PDR controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the PDR database 1019, operating systems, other program components, user interfaces, Web browsers, and/or the like.

Access to the PDR database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the PDR. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the PDR as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1017 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1018 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the PDR enabled nodes. The combined application may be nugatory on systems employing standard Web browsers.

### Mail Server

A mail server component 1021 is a stored program component that is executed by a CPU 1003. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the PDR.

Access to the PDR mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1022 is a stored program component that is executed by a CPU 1003. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1020 is a stored program component that is executed by a CPU 1003, cryptographic processor 1026, cryptographic processor interface 1027, cryptographic processor device 1028, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the PDR may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to allow the PDR component to engage in secure transactions if so desired. The cryptographic component facilitates the secure accessing of resources on the PDR and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The PDR Database

The PDR database component 1019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the PDR database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the PDR database is implemented as a data-structure, the use of the PDR database 1019 may be integrated into another component such as the PDR component 1035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1019 includes several tables 1019a-g. A Consumer Accounts table 1019a includes fields such as, but not limited to: a consumer_id, consumer_ssn, consumer_first_name, consumer_last_name, consumer_issuer_bank_account_information, consumer_creditcard_institution_account_information, consumer_credit_rating, and/or the like. The user table may support and/or track multiple consumer accounts on a PDR. A Consumer Devices table 1019b includes fields such as, but not limited to: consumer_id, consumer_mobile_device_id, consumer_communication_device_id, consumer_computer_device_id, device_communication_protocol, preferred_device_indicator, preferred_messaging_format, and/or the like. A Consumer Transactions table 1019c includes fields such as, but not limited to: consumer_id, transaction_time, transaction_date, merchant_name, transaction_status, transaction_payment_amount, transaction_currency, purchase_item_description, purchase_item_category_code and/or the like. A Merchant Promotional Offers table 1019d includes fields such as, but not limited to: merchant_name, merchant_id, promotion_item_category_code, promotion_item_description, promotion_information, promotion_expiry_date, and/or the like. An Issuers table 1019e includes fields such as, but not limited to: issuer_name, issuer_id_number and/or the like. A Merchants table 1019f includes fields such as, but not limited to: merchant_name, merchant_id_number, merchant_business_category, merchant_acquirer_bank, merchant_provided_goodsList, merchant_provided_ServicesList and/or the like. Further, a User Interface (UI) table 1019g includes fields such as, but not limited to: goods_service_category, goods_service_items, manufacturer_provider, manufacturer_provider_search, cellular_device, laptop_device, PDA_device, home_computer1, home_computer2, work_computer, PromotionalOffer_AND_ConsumerTransactionData, PromotionalOffer_AND_SalesTransactionData, PromotionalOffer_AND_SMSData, PromotionalOffer_AND_EmailData and/or the like. In one embodiment, the PDR database may interact with other database systems. For example, employing a distributed database system, queries and data access by search PDR component may treat the combination of the PDR database, an integrated data security layer database as a single database entity.

In one embodiment, user programs may contain various user interface primitives, which may serve to update the PDR. Also, various accounts may require custom database tables depending upon the environments and the types of clients the PDR may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1019a-g. The PDR may be configured to keep track of various settings, inputs, and parameters via database controllers.

The PDR database may communicate to and/or with other components in a component collection, including itself, and/or facilities of the like. Most frequently, the PDR database communicates with the PDR component, other program components, and/or the like. The database may contain, retain, and provide information regarding other nodes and data.

### The PDRs

The PDR component 1035 is a stored program component that is executed by a CPU. In one embodiment, the PDR component incorporates any and/or all combinations of the aspects of the PDR that was discussed in the previous figures. As such, the PDR affects accessing, obtaining and the provision of information, services, transactions, and/or the like across various communications networks.

The PDR component transforms merchant promotional offer inputs, user or consumer-sent information (e.g., purchase receipt data), and individual user or consumer transaction inputs via a PDR retrievable account information component, a PDR purchase information transfer component, and a PDR purchase activity process component into offer data, transaction authorization requests, retrieved transaction data, retrieved offer information, retrieved user account information, sent user account information, and targeted offer (e.g., promotions) outputs that are distributed to individual user or consumers.

The PDR component providing access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the PDR server employs a cryptographic server to encrypt and decrypt communications. The PDR component may communicate to and/or with other components in a component collection, including itself, and/or facilities of the like. Most frequently, the PDR component communicates with the PDR database, operating systems, other program components, and/or the like. The PDR may contain, communicate, generate, obtain, and/or provide program component, system, user, and/or data communications, requests, and/or responses.

### Distributed PDRs

The structure and/or operation of any of the PDR node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the PDR controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the PDR controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
    $input = “”;
    $input = socket_read($client, 1024);
    $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=
/com.ibm.IBMDI.doc/referenceguide259.htm

all of which are hereby expressly incorporated by reference.

In order to address various issues and improve over previous works, the application is directed to APPARATUSES, METHODS AND SYSTEMS FOR USING A PERSONALIZED DATA REPOSITORY. The entirety of this application (including the Cover Page, Title, Headings, Field, Background, Summary, Brief Description of the Drawings, Detailed Description, Claims, Abstract, Figures, Appendices, and otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a PDR individual and/or enterprise user, database configuration and/or relational model, data type, data transmission and/or network framework, syntax structure, and/or the like, various embodiments of the PDR, may be implemented that provide a great deal of flexibility and customization. For example, aspects of the PDR may be adapted for generating targeted promotional offers to user or consumers based on the vast array of data information that is available to payment processing networks (e.g., VisaNet™). While various embodiments and discussions of the PDR have been directed to generating targeted promotional offers, however, it is to be understood that the embodiments described herein may be readily configured and/or customized for a wide variety of other applications and/or implementations.

What is claimed is:

1. A personalized data repository processor-implemented method, comprising:
receiving, over a communications network, a user's sale transaction information corresponding to purchased goods information or purchased services information, wherein the user's sale transaction information is aggregated and packaged from an authorized mobile communication device of the user;
receiving, over the communications network, merchant promotional offer information corresponding to promotional goods information or promotional services information;
correlating the received user's sale transaction information with the received promotional offer information for determining one or more targeted promotional offers based on the promotional goods or promotional services information and the purchased goods or purchased services information; and
sending, over the communications network, the one or more targeted promotional offers to the mobile communication device.

2. The method of claim 1, wherein the user's sale transaction information is received from a plurality of merchant point-of-sale terminals.

3. The method of claim 1, wherein the user's sale transaction information is received from the mobile communication device of the user.

4. The method of claim 1, wherein the user's sale transaction information is received from at least one other mobile communication device of the user.

5. The method of claim 1, wherein the correlating is based on a pre-designated threshold above which a substantial correlation is determined.

6. The method of claim 1, wherein the user's sale transaction information includes both authorized and unauthorized sale transactions associated with the user.

7. The method of claim 6, wherein the authorized sale transactions are correlated prior to the unauthorized sale transactions.

8. The method of claim 6, wherein the unauthorized sale transactions selected for correlation are restricted to a predetermined purchase value.

9. The method of claim 1, wherein the user's sale transaction information includes user financial account information.

10. The method of claim 1, wherein the user sale transaction information includes user mobile communication device identifier information, wherein the one or more targeted promotional offers are sent to the mobile communication device based on the user mobile communication device identifier information.

11. The method of claim 10, wherein the one or more targeted promotional offers are sent to other mobile communication devices of the user that are identified within the user mobile communication device identifier information.

12. The method of claim 1, wherein the one or more targeted promotional offers comprise at least one of a PDF file, at least one hyperlink, and at least one barcode image.

13. A personalized data repository system, comprising:
a memory; and
a processor disposed in communication with the memory and configured to issue processing instructions stored in the memory to:
receive, over a communications network, a user's sale transaction information corresponding to purchased goods information or purchased services information, wherein the user's sale transaction information is aggregated and packaged from an authorized mobile communication device of the user;
receive, over the communications network, merchant promotional offer information corresponding to promotional goods information or promotional services information;
correlate the received user's sale transaction information with the received promotional offer information for determining one or more targeted promotional offers based on the promotional goods or promotional services information and the purchased goods or purchased services information; and
send, over the communications network, the one or more targeted promotional offers to the mobile communication device of the user.

14. A processor-readable tangible medium storing processor-issuable personalized data repository instructions to:
receive, over a communications network, a user's sale transaction information corresponding to purchased goods information or purchased services information, wherein the user's sale transaction information is aggregated and packaged from an authorized mobile communication device of the user;
receive, over the communications network, merchant promotional offer information corresponding to promotional goods information or promotional services information;
correlate the received user's sale transaction information with the received promotional offer information for determining one or more targeted promotional offers based on the promotional goods or promotional services information and the purchased goods or purchased services information; and
send, over the communications network, the one or more targeted promotional offers to a mobile communication device.

15. A personalized data repository processor-implemented method, comprising:
receiving, over a communications network, a user's account information;
storing the received user's account information at a database;
receiving, from the user's mobile communication device, a request message for accessing the user's account information;
retrieving, from the database, the user's account information in response to the request message; and
sending, to the user's mobile communication device, the retrieved user's account information,
wherein based on the user's account information that is sent to the user's mobile communication device, the user's mobile communication device engages in at least one financial transaction, wherein sale transaction information associated with the at least one financial transaction is, upon authorization, aggregated and packaged from the user's mobile communication device.

16. The method of claim 15, wherein the user's mobile communication device communicates with a merchant point-of-sale (POS) terminal by generating wireless signals carrying an encrypted version of the user's account information during the at least one financial transaction.

17. The method of claim 16, wherein the user's mobile communication device communicates with the merchant point-of-sale (POS) terminal utilizing Near Field Communication (NFC) technology.

18. The method of claim 15, wherein the user's account information comprises at least one of user bank account information and user credit-card information.

19. The method of claim 15, further comprising:
storing the user's account information on the user's mobile communication device for a predetermined time period; and
permanently removing the stored user's account information from the user's mobile communication device after a lapse of the predetermined time period,
wherein the removing of the stored user's account information provides information security by reducing access to the user's account information via the user's mobile communication device.

20. A personalized data repository system, comprising:
a memory; and
a processor disposed in communication with the memory and configured to issue processing instructions stored in the memory to:
receive, over a communications network, a user's account information;
store the received user's account information at a database;
receive, from the user's mobile communication device, a request message for accessing the user's account information;
retrieve, from the database, the user's account information in response to the request message; and
send, to the user's mobile communication device, the retrieved user's account information,
wherein based on the user's account information that is sent to the user's mobile communication device, the user's mobile communication device engages in at least one financial transaction, wherein sale transaction information associated with the at least one financial transaction is, upon authorization, aggregated and packaged from the user's mobile communication device.

21. A processor-readable tangible medium storing processor-issuable personalized data repository instructions to:
receive, over a communications network, a user's account information;
store the received user's account information at a database;
receive, from the user's mobile communication device, a request message for accessing the user's account information;
retrieve, from the database, the user's account information in response to the request message; and
send, to the user's mobile communication device, the retrieved user's account information,
wherein based on the user's account information that is sent to the user's mobile communication device, the user's mobile communication device engages in at least one financial transaction, wherein sale transaction information associated with the at least one financial transaction is, upon authorization, aggregated and packaged from the user's mobile communication device.

22. A personalized data repository processor-implemented method, comprising:
receiving, over a communications network, communication messages associated with a user's mobile communication device, wherein the communication messages associated with the user's mobile communication device are aggregated and packaged, upon authorization, from the mobile communication device;
storing the communication messages at a database;
receiving, over the communications network, merchant promotional offer information corresponding to promotional goods information or promotional services information;
processing the stored communication messages by extracting keywords associated with particular goods or services from the communication messages;
correlating the extracted keywords with the promotional goods or promotional services information for determining one or more targeted promotional offers; and
sending, over the communications network, the one or more targeted promotional offers to the user's mobile communication device.

23. The method of claim 22, wherein the communication messages are short message service (SMS) messages.

24. The method of claim 22, wherein the communication messages are internet-based email account messages.

25. The method of claim 22, wherein the one or more targeted promotional offers comprise at least one of a PDF file, at least one hyperlink, and at least one barcode image.

26. A personalized data repository system, comprising:
a memory; and
a processor disposed in communication with the memory and configured to issue processing instructions stored in the memory to:
receive, over a communications network, communication messages associated with a user's mobile communication device, wherein the communication messages associated with the user's mobile communication device are aggregated and packaged, upon authorization, from the mobile communication device;
store the communication messages at a database;
receive, over the communications network, merchant promotional offer information corresponding to promotional goods information or promotional services information;
process the stored communication messages by extracting keywords associated with particular goods or services from the communication messages;
correlate the extracted keywords with the promotional goods or promotional services information for determining one or more targeted promotional offers; and
send, over the communications network, the one or more targeted promotional offers to the user's mobile communication device.

27. A processor-readable tangible medium storing processor-issuable personalized data repository instructions to:
receive, over a communications network, communication messages associated with a user's mobile communication device, wherein the communication messages associated with the user's mobile communication device are aggregated and packaged, upon authorization, from the mobile communication device;
store the communication messages at a database;
receive, over the communications network, merchant promotional offer information corresponding to promotional goods information or promotional services information;
process the stored communication messages by extracting keywords associated with particular goods or services from the communication messages;
correlate the extracted keywords with the promotional goods or promotional services information for determining one or more targeted promotional offers; and
send, over the communications network, the one or more targeted promotional offers to the user's mobile communication device.
